(19) United States
(12) Patent Application Publication
(10) Pub. No.: US 2010/0218906 A1
(43) Pub. Date: Sep. 2, 2010

(54) Modular Shade System

(75) Inventors: Tony MARZILLI, Mississauga (CA); Gianpaolo CARMELI, Monsano (IT)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: TRIBUTE WINDOW COVERINGS INC., Mississauga (CA)

(21) Appl. No.: 12/394,838

(22) Filed: Feb. 27, 2009

(51) Int. Cl. E06B 9/00; A47B 96/06

(52) U.S. Cl. 160/368.1; 248/201; 160/405

(57) ABSTRACT

In an aspect of the invention there is a modular system for covering an object with a shade, the object having a dimension. The system comprising, a predetermined number of sized track members cut from at least one longer elongated track member, each sized track member defining a longitudinal channel therein; wherein the predetermined number is selected based on the dimension of the object, a plurality of brackets for supporting the sized track members in a substantially parallel and eccentric relationship, the plurality of brackets comprising at least one first bracket having the predetermined number of apertures to secure the predetermined number of sized track members, and a slider connected to each of the sized track members, the slider comprising a first end movably engaging the longitudinal channel of the sized track member and a second end adapted to be secured to an upper edge of the shade.

### FIELD

This application relates generally to coverings for windows, doors, openings, walls or the like. In particular, this application relates to a modular system for covering an object with a shade.

### BACKGROUND

Shade systems for covering a window, door or the like are well known. One example of a prior art multi-channel track 100 is shown in FIG. 1.

The multi-channel track 100 is typically used in combination with a plurality of sliders supporting a plurality of fabric panels. Each slider and supported panel in the system is typically moveable along the length of a corresponding channel within the multi-channel track 100. The number of channels 103, and corresponding sliders and panels, within a given multi-channel system is typically based on the size of the object to be shaded and the aesthetic demands of the user.

Each slider within a channel 103 typically supports one hanging panel. The hanging panel is typically connected to the slider using a releasable fastener to allow a user to easily, and repeatedly attach and detach the hanging panel from the slider. One known method of attaching the hanging panel to the slider is the use of hook-and-loop type fasteners.

The prior art multi-channel track 100 has a number of disadvantages. One of the disadvantages of the prior art multi-channel track 100, shown in FIG. 1, is that for any given number of channels required by a user, a custom track containing the desired number of channels must be manufactured. Another disadvantage of the known multi-channel track system is the fact that the multi-channel track 100 has the same number of channels along its entire length, which tends to limit the flexibility of installation variations.

Yet another disadvantage of the known multi-channel track systems is the fact that the hook-and-loop fastener used to attach the hanging panel to the slider tends to weaken after repeated use, and over time in general. Also, hook-and-loop fasteners typically have a maximum attachment strength, which tends to limit the weight of the hanging panels, reducing the material options available to the user.

### SUMMARY

In an aspect of the invention there is provided a modular system for covering an object with a shade, where the object has a dimension. The system comprises a plurality of substantially identical track members, where each track member defines a longitudinal channel therein. At least one bracket is adapted to connect a predetermined number of the plurality of track members in substantially parallel relation, wherein the predetermined number is selected based on the dimension of the object. The modular system further comprising a slider movably connected to each of the predetermined number of track members. The slider comprises a first end movably engaging the longitudinal channel of the track member, and a second end adapted to be secured to an upper edge of the shade.

In another aspect of the invention there is provided a method for covering an object with a shade where the object has a dimension. The method comprises: i) providing at least one track member defining a longitudinal channel therein, ii) cutting the at least one track member into a predetermined number of sized track members, wherein the predetermined number of sized track members is based on the dimension of the object, iii) selecting a first group of brackets from a plurality of brackets, wherein the first group of brackets comprises at least one bracket having a number of apertures equal to the predetermined number, iv) attaching the predetermined number of sized track members to the first group of brackets, wherein the sized track members are in substantially parallel relation and eccentric to each other, and connecting at least one slider to a longitudinal channel defined in each sized track member. Each slider comprising a first end for movably engaging the longitudinal channel of the sized track member and a second end adapted to be secured to an upper edge of a shade.

In yet another aspect of the invention, there is provided a modular system for covering an object with a shade, where the object has a dimension. The system comprises, a predetermined number of sized track members cut from at least one longer elongated track member. Each sized track member defines a longitudinal channel therein, wherein the predetermined number is selected based on the dimension of the object. The system also comprises a plurality of brackets for supporting the sized track members in a substantially parallel and eccentric relationship. The plurality of brackets comprising at least one first bracket, having the predetermined number of apertures to secure the predetermined number of sized track members, and a slider connected to each of the sized track members. The slider comprises a first end movably engaging the longitudinal channel of the sized track member, and a second end adapted to be secured to an upper edge of the shade.

In yet another aspect of the invention, there is provided a slider for supporting a hanging panel within a modular system for covering an object with a shade. The hanging panel has an attachment portion and a hanging portion. The slider comprises: i) a track engaging section for movably engaging a supporting track member, ii) a panel attachment section, for supporting a corresponding attachment portion of the hanging panel. The panel attachment section comprises: i) an elongated channel, the elongated channel having at least one open end and, ii) a gap that defines a longitudinal opening along the elongated channel. The elongated channel is wider than the attachment portion of the hanging panel to slidingly receive the attachment portion via the at least one open end. The gap is wider than the hanging portion of the hanging panel and narrower than the attachment portion of the hanging panel. The gap is sized to slidingly receive the hanging portion of the hanging panel and contain the attachment portion of the hanging panel within the elongated channel.

Further aspects and advantages of the embodiments described herein will appear from the following description taken together with the accompanying drawings.

### BRIEF DESCRIPTION OF THE DRAWINGS

For a better understanding of the embodiments described herein, and to show more clearly how they may be carried into effect, reference will now be made, by way of example only, to the accompanying drawings which show at least one exemplary embodiment, and in which:

FIG. 1 is a perspective view of a shade apparatus known in the prior art;

FIG. 2 is an exploded perspective view of a modular shade apparatus according to an aspect of the present invention;

FIG. 3 is a partial perspective view of the modular shade apparatus of FIG. 2;

FIG. 4 is an end view of the modular shade apparatus of FIG. 2;

FIG. 4A is a section view of the modular shade apparatus of FIG. 4, taken along line 4A-4A;

FIG. 5 is an elevation view of another embodiment of a modular shade apparatus;

FIG. 6 is a perspective view of the modular shade apparatus of FIG. 5;

FIG. 7 is a side view of the modular shade apparatus of FIG. 5;

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION OF VARIOUS EMBODIMENTS

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

As used herein, the “top” of the track is the surface that connects to the brackets. Conversely, “bottom” of the track is the portion of the track that engages the sliders. Other components of the modular shade apparatus may also be described in a similarly fashion, such as the surface described herein may be described as a ceiling that is above the tracks, and the panels may be described as hanging down from, or being suspended from, the sliders. These relations are used for clarity and convenience and should not be construed as limiting the orientation or spatial relation of any of the elements of the invention described herein.

According to an embodiment of the invention, there is provided a modular shade system for shading, or otherwise covering, an object. For clarity, the object may be understood to be a window, and the modular shade system can be understood as serving as a window covering, curtain or blind system. However, it is understood by those of ordinary skill in the art that the object may be a variety of structural or decorative features, including a doorway, a portion of a wall, a painting, a television and a second portion of the room itself, or the like.

An advantage of the modular shade system is its modular nature. Specifically, in some embodiments of the invention the modular shade system comprises a plurality of substantially identical tracks that are arranged substantially parallel to each other. Each track may be uniform in cross-section and defines a single channel for receiving a slider and hanging panel to shade at least a portion of the object.

In a preferred embodiment, a supplier may stock an inventory of track members that are longer than typically used in a modular shade system installation. A user may request a shade system to fit a particular application, for example to cover a large living room window. The user, perhaps in consultation with the supplier, may determine, for example, that she desires a shade system that is 10 feet wide and has 5 hanging panels (each hanging panel being approximately 2 feet in width). Having determined that a modular shade system requires 5 tracks to support 5 hanging panels, the supplier may cut one of the longer track members in inventory into the desired number of tracks, 5 in this example. Tracks formed in this manner may also be referred to as sized track members. Because the specific number of track members in the modular shade system is based on the object to be covered, as well as a user's aesthetic preferences, it is advantageous for a supplier to simply cut the desired number of tracks from an inventory of longer track members, as opposed to having to custom-manufacture a multi-channel track.

The plurality of tracks may be coupled together in the parallel configuration using a plurality of brackets. The brackets are configured to have a number of apertures that correspond to the number of tracks used in any given system. Continuing the example outlined above, the supplier may select several brackets having 5 apertures to give to the user in combination with the 5 sized track members cut from the longer inventory track.

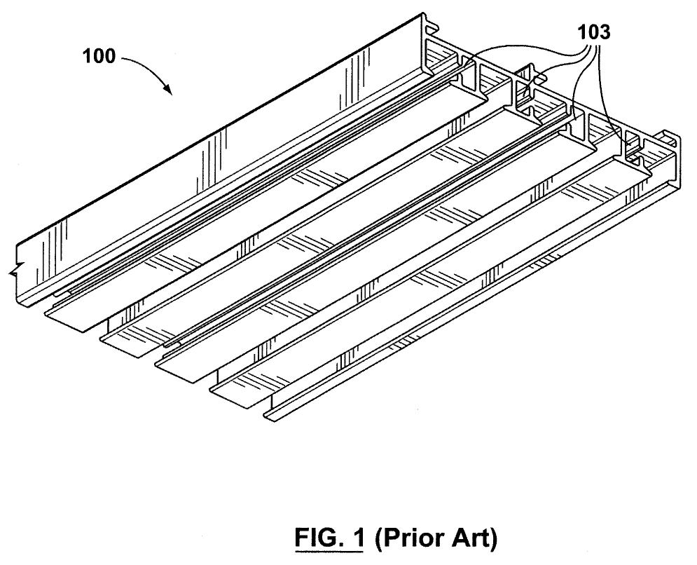

The modular nature of the modular shade system allows a supplier to provide a variety of shade systems, keeping only a selection of brackets and some longer lengths of track in stock. For example, if the user in the previous example happened to change her mind and request a 6-panel system, a supplier using an embodiment of the current invention would simply cut an additional sized track member from his inventory of longer track members, and supply the user with 6-track, instead of 5-track, brackets. In contrast, a supplier using a system known in the prior art, as shown in FIG. 1, would have to manufacture an entirely new 6-channel track, and discard the previously created 5-channel track. A detailed description of the modular shade system follows below.

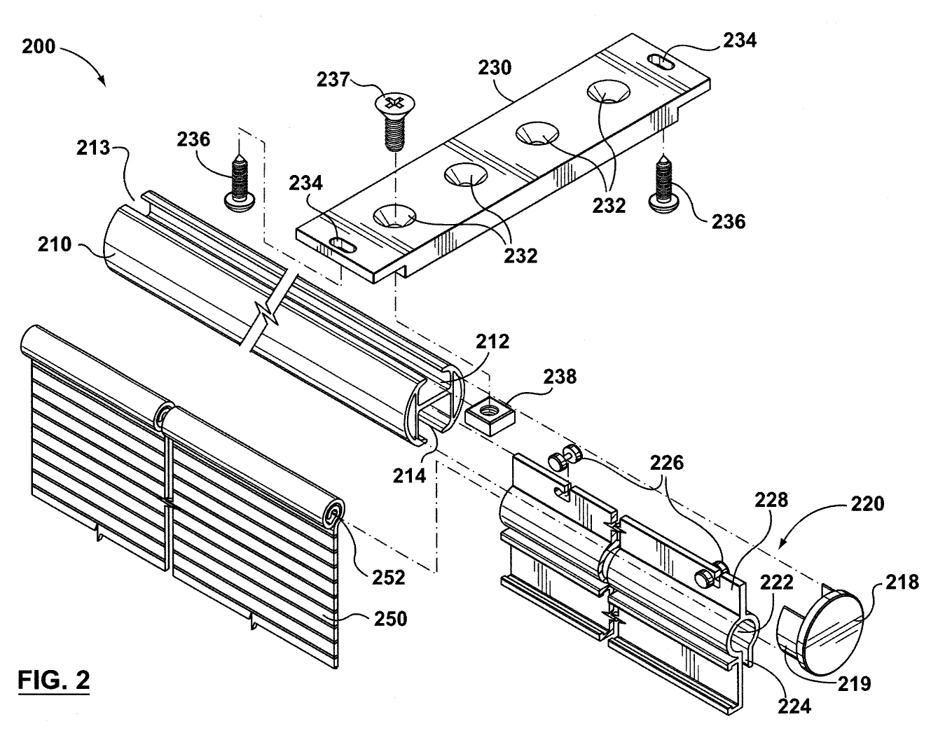

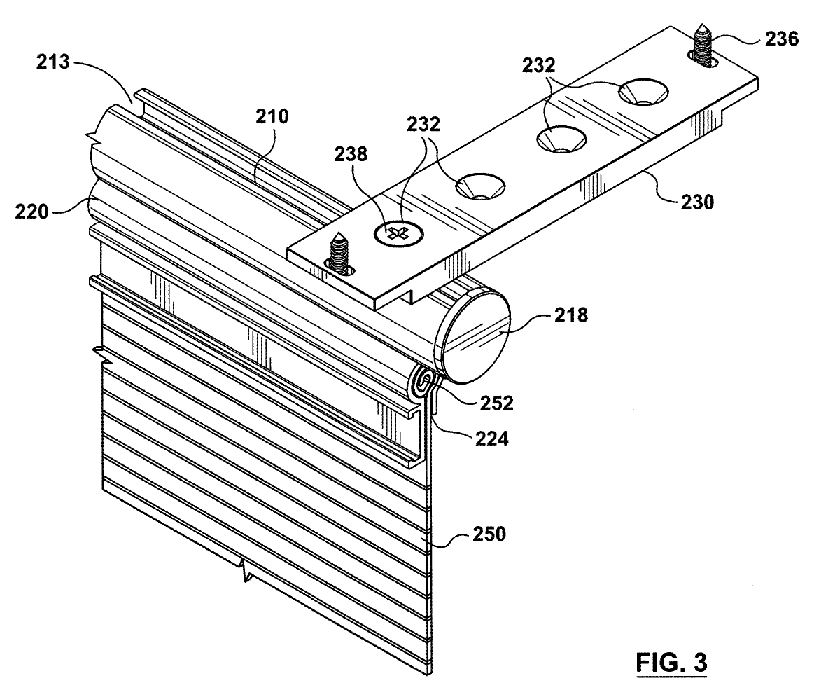

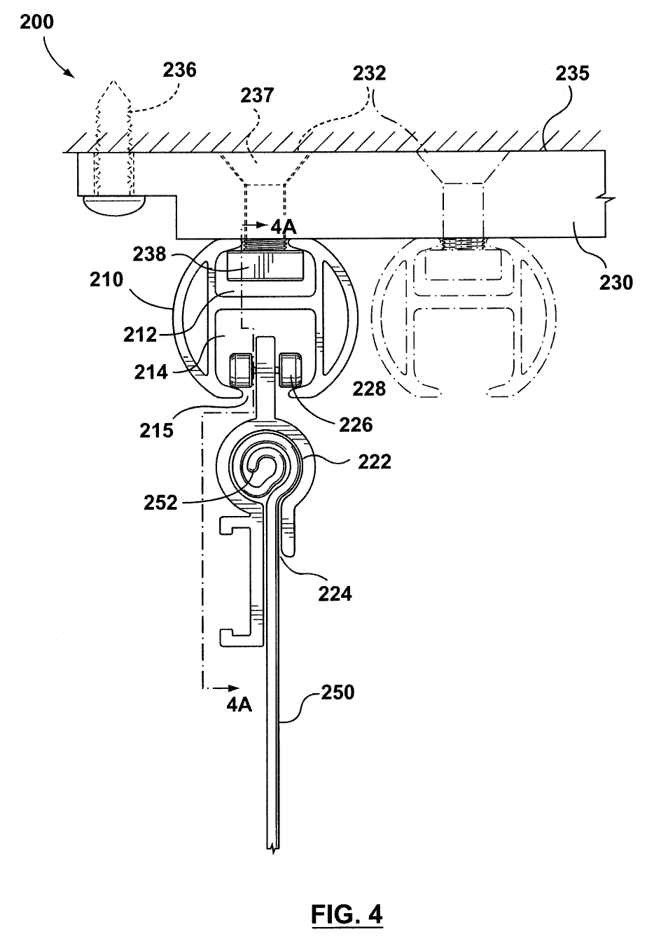

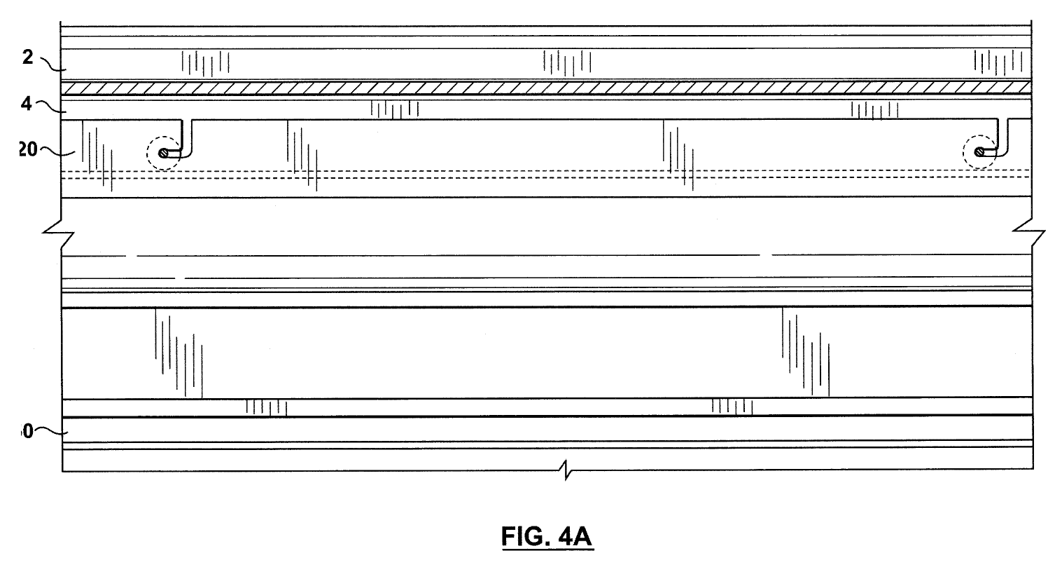

Referring to FIGS. 2-4A, a modular shade system 200, according to a preferred embodiment of the present invention, may include one or more tracks 210, one or more sliders 220, and one or more brackets 230. For clarity only one of the tracks 210, sliders 220 and brackets 230 are illustrated in FIGS. 2-4A. The modular shade system 200 may also include one or more hanging panels 250. The modular shade system 200 may be mounted to a surface 235, in a location where the hanging panel 250 can shade, or otherwise cover, an object, such as a window. The modular shade system 200 may be used to construct a window covering assembly that includes several tracks 210 arranged in a substantially parallel configuration. In such an assembly, each of the tracks 210 may support a corresponding hanging panel 250 and the window may be shaded by the combination of hanging panels 250.

The track 210 may be an extruded channel formed from aluminum or any other suitable material. Aluminum is a preferred material because of its mechanical and aesthetic properties. The track 210 may be of a generally round cross-sectional shape, and may comprise internal partitions that define a longitudinal mounting channel 212 and a longitudinal sliding channel 214 within the track 210. The top and bottom of the track 210 may be flattened to create an upper flat plane of the track 210 to abut the bracket 230, and to create a lower flat plane that is substantially parallel with the top margin of the hanging panel 250 suspended from the slider 220.

Both ends of the track 210 may be capped by an end cap 218. The end caps 218 may be formed from the same material as the track 210, or they may be formed from another suitable material. The end caps 218 may serve to contain the slider 220 within the track 210 and may improve the aesthetic appearance of the assembled modular shade system 200 by obscuring the otherwise exposed internal members and channels 212, and 214 within the track 210. The embodiment of the end caps 218 shown in the figures are releasably held in place by an interference fit between the end cap tabs 219 and the track 210 side channels 216. It is understood that the end caps 218 may be held in place using any other suitable method known in the art, including adhesives, set screws, screws, and clips.

The mounting channel 212 is configured to receive an appropriate fastener that is used to attach the track 210 to the bracket 230. The fastener is preferably a nut 237 and bolt 238 as shown. The mounting channel 212 may be configured to slidingly receive the nut 237 thereby allowing the nut 237 to be moved along the length of the track 210 until it is positioned at a location that corresponds to a desired bracket mounting location. Once so positioned, the nut 237 may be engaged by the corresponding threads of a bolt 238 that passes through an aperture 232 in bracket 230. The bolt 237 is then tightened to secure the track 210 to the bracket 230. Additional brackets can be secured to the track in the same manner as described above.

The nut 237 may have a square shape, or other suitable shape such that its rotation is constrained by the walls of the mounting channel 212. With the rotation of the nut 237 constrained by the sliding channel 212, the rotation of the bolt 238 may tend to draw the nut 237, and track 210, toward the bracket 230 until the top surface of the track 210 abuts the bottom surface of the bracket 230.

As shown, the aperture 232 may be a countersunk hole, and the bolt 238 may have a corresponding countersunk head profile to allow the top of the bolt 238 to lie substantially flush with the upper surface of the bracket 230, thereby creating a substantially smooth surface for engaging the external surface 235.

The track 210 may be supported by a number of brackets 230 along its length, and therefore a preferably corresponding number of nuts 237 may be located within the mounting channel 212.

The mounting channel 212 has so far been described as a continuous channel running the entire length of the track 210, to allow positioning of a nut 237, or the plurality of nuts 237, anywhere along the length of the track 210. The ability to position the nuts 237 at a plurality of locations along the mounting channel 212 may allow a user or modular shade system 200 installer to be flexible with placement of the mounting brackets 230 within a given user's room. It is understood, however, the track 210 could be configured with a plurality of discrete mounting openings instead of continuous mounting channel 212.

After all the tracks 210 have been attached to their respective brackets 230, each bracket 230 may be attached to a supporting external surface 235, such as a ceiling, floor, bulkhead, shelf or wall, using fasteners 236 received within surface mounting points 234. While the fasteners 236 in the FIG. 2 are shown as screws, it is understood that any other suitable fasteners could be used, including nails, rivets, bolts, tape, glue, magnets, welds or chemical adhesives.

The track 210 also includes a sliding channel 214 having a sliding opening 215. Much like the mounting channel 212 described above, the sliding channel 214 is a defined by inner partitions of the track 210 and preferably runs along the entire length of the track 210. The sliding channel 214 is configured to moveably support a slider 220. The sliding channel 214 defines a corresponding sliding opening 215 that allows the at least one portion of the slider 220 to be received within the sliding channel 214 while at least one other portion of the slider 220 remains external the sliding channel 214.

The slider 220 is configured to be moveably supported by the sliding channel 214 and to in turn support a hanging panel 250 for covering or shading the window or other object. To that end, the slider 220 may have a panel attachment section 222 and a track engaging section 228. In general a track 210 supports a single slider 220 within its sliding channel 214. However, it is understood that an track 210 could support multiple sliders 220 in some shade systems constructed using the modular shade system 200.

In the slider 220 shown, the track engaging section 228 comprises a plurality of rollers 226 for engaging the sliding channel 214. The number of rollers 226 on a slider 220 may depend on the length of the slider 220, as well as, the weight of the hanging panel 250 it is supporting. The sliders 220 in the FIGS. 2-7 are shown with two rollers 226, but it is understood that the slider 220 may have any suitable number of rollers 226. It is also understood, however, that the track engaging section 228 could comprise elements other than rollers 226 including, skids, ball bearings, skis or any other suitable track contacting members.

Being supported by the rollers 226, the slider 220 and hanging panel 250 are freely moveable along the track 210 within the sliding channel 214. In such a configuration, the slider 220 may be moved to a plurality of positions along the length of the track 210 by a force exerted on the slider 220 by a user, or by any other means. While the slider 220 and hanging panel 250 may be moveable to a plurality of positions along the length of the track 210, a typical user of a window covering constructed from the modular shade system 200 may tend to move the slider 220 and hanging panel 250 between a first, open or uncovered or unshaded, position and a second, closed or covered or shaded position.

For example, when the window covering constructed from the modular shade system 200 is installed in proximity to a window in a room, the first position may be the position along the track 210 where the slider 220 and hanging panel 250 do not overlap the window. This may be described as an open position. The second position may then be the position along the track 210 where the slider 220 and hanging panel 250 completely overlap the window. This may be described as the closed or shaded position because the hanging panel 250 may substantially block any external light from entering the room via the window. During normal operation of the modular shade system 200, a user may tend to move the slider 220 and hanging panel 250 between the open and closed position in response to the user's needs. For example, a user may move the hanging panel 250 to an open position if she wants to allow sunlight into the room during the day, and the user may move the hanging panel 250 into the closed position if she wishes to obscure the window and darken the room while watching television or a movie.

The hanging panel 250 may be made of any type of material with the properties desired by the user. For example, the hanging panel 250 may be made from fabric so that it resembles traditional drapes or window coverings. The fabric chosen may be opaque to inhibit light transmission, translucent to permit light transfer but block human vision or substantially transparent to allow both light transfer and human vision. In addition to fabric or cloth, the hanging panel 250 may also be formed from a variety of other materials including wood, plastic and metal.

The hanging panel 250 may be a single, continuous sheet of material, or it may be provided with a plurality of apertures or formed from a plurality of slats or sections. For example, the panel 250 may be formed from a plurality horizontal slats of wood, or other material, secured by vertical string members. Such a panel may be used to compliment an Asian themed interior design scheme. It is understood by those skilled in the art that the hanging panel 250 may be formed from a wide range of materials.

The hanging panel 250 is supported by the slider 220 at the panel attachment section 222. The hanging panel 250 may have a corresponding attachment portion 252 for engaging the panel attachment section 222 of the slider 220.

In the examples of window coverings shown, the panel attachment section 222 of the slider 220 is a channel of a generally round, cross-section that runs the length of the slider 220 and has a bottom gap 224 for allowing a portion of the hanging panel 250 to pass through. In the window coverings shown, the corresponding attachment portion 252 of the hanging panel 250 may be any suitable structure having a width greater than the bottom gap 224. For example, the structure may be a bead at the top of the panel 250 or a fold at the top of the panel 250.

If the hanging panel 250 comprises a plurality of wooden slats, the attachment portion 252 may be a slat that is thicker than the other members, or perhaps a combination of two more slats that will not pass through the gap in the slider 220. Using this attachment means the hanging panel 250 attachment portion 252 may be inserted into an end of the slider 220 channel and threaded along the length of the slider 220.

Other possible embodiments of the panel attachment section 222 and corresponding attachment portion 252 include matching hook-and-loop fasteners, releasable clips, hooks and grommets, tape, chemical adhesives, screws and magnets. Connecting the hanging panel 230 using the slider channel as described herein may be advantageous for a user because other attachment methods (hook-and-loop, tape, adhesives, etc.) may tend to weaken or fail over prolonged use of the modular shade system 200.

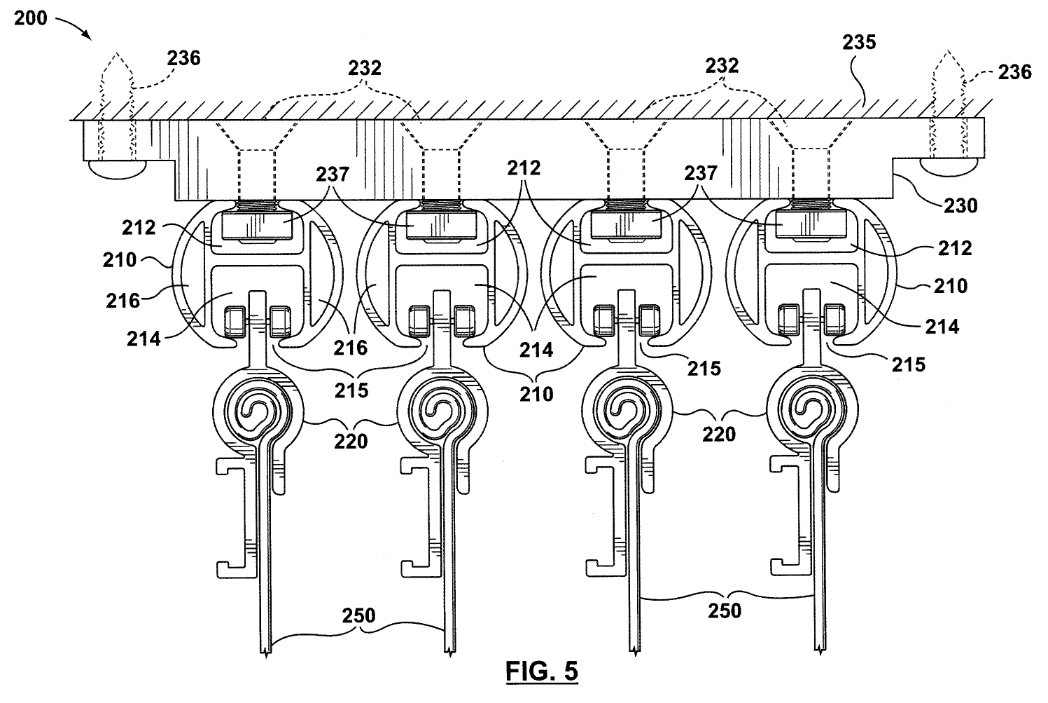

If the object, for example the window described above, is relatively small it may be covered by a single hanging panel 250. However, if the object is relatively large, or if the user simply wishes to cover the object with a plurality of smaller panels instead of a single, large panel, a plurality of tracks 210 may be installed in parallel form, as shown in FIGS. 5-7.

Referring to FIGS. 5-7, a window covering constructed from the modular shade system 200 which includes four parallel tracks 210 may be assembled. Each track 210 in the four-track modular shade system 200 may be substantially identical, and in some window coverings, at least a portion of the tracks 210 are cut from a single, longer track member.

Previously, if a user wanted a four-track apparatus to cover a window in her home she may have had to order a custom-extruded, multi-track unitary shade apparatus, similar to the apparatus shown in FIG. 1. Ordering a custom-extruded multi-channel track may be expensive, may increase the delivery time of the product (as all retailers may not stock lengths of a variety of custom tracks) and may decrease installation flexibility. For example, installing a unitary shade apparatus to shade a window may require a custom piece of multi-channel track to be extruded to the exact length of the window. Installing a multi-channel track may also require that each channel run the entire width of the window, even if such a configuration is not needed or desired.

In contrast, using the modular shade system 200 to construct a window covering may be relatively lower cost, may decrease the delivery time of the product, and may increase design and installation flexibility.

A benefit associated with a modular shade system 200 may be the result of the modular nature of the tracks 210 and brackets 230. Specifically, each of the tracks 210 required for a given installation may be cut from a longer length of track 210 kept in stock by a retailer. In such a system, a plurality of longer track members can be manufactured in bulk by a manufacturer and then shipped to a local retailer. When given a specific request by a user, the retailer can then simply cut the longer track members into a plurality of appropriately sized tracks 210 for a given user. For example, if a user requests a four-track system to cover a window, the retailer may simply cut four, appropriately sized tracks 210 from his stock of uniform, longer track members without having to place a special order with the manufacturer for a custom extruded four-channel track. In order to assemble and install the four-track system, the retailer may also provide a plurality of brackets 230, each bracket 230 having an appropriate number of apertures 232, as shown in FIGS. 5 - 7. Once assembled, the four-track modular window shade constructed using the shade system 200 may include four sliders 220 supporting four corresponding hanging panels 250 that are moveable along the length of their respective tracks 210.

In one embodiment of a four-panel window covering constructed from the modular shade system 200, each hanging panel 250 may be the full width of the window, and positioning a varying number of hanging panels 250 in front of the window may lead to varying levels of light transmission into the room. In another embodiment of a four-panel window covering, each hanging panel 250 may be only a fraction of the width of the window, for example 1/4 of the width. In this configuration, the window may be covered when all four hanging panels 250 are aligned edge-to-edge, and may be uncovered when all four hanging panels 250 are moved from in front of the window. In some uncovered configurations, all four hanging panels 250 may be moved to the same side of the window, effectively moving into a stacked configuration where the four hanging panels 250 are substantially aligned with each other. In another configuration, two hanging panels 250 may be positioned on either side of the window, thereby creating a two panel stack on each side of the window. The window may also be partially covered when a user positions any, or all, of the four hanging panels 250 in location intermediate the fully covered and fully open positions.

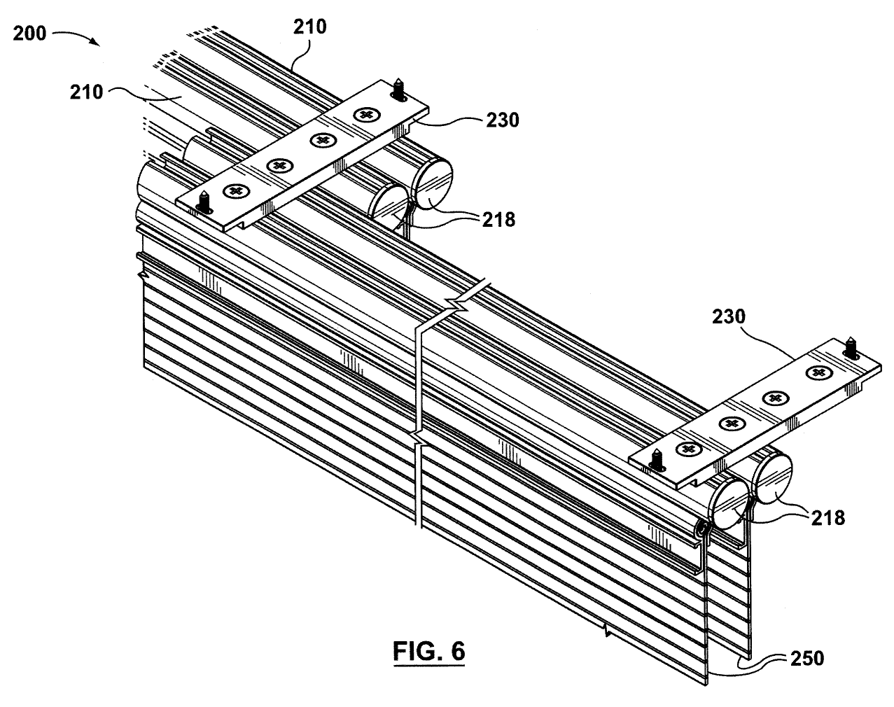

In yet another embodiment, a user may take advantage of the modular nature of the modular shade system 200 by varying the number of tracks 210 used along the entire length of a window covering. For example, as shown in FIG. 6, a user may request that a portion of the window covering have four overlapping tracks 210 (as shown in the left most bracket 230 in FIG. 6) while another portion of the window covering has only two overlapping tracks 210 (as shown in the right most bracket 230 in FIG. 6). While both brackets 230 in FIG. 6 are shown with four apertures 232, it is understood that brackets 230 can be formed with any desired number of apertures 232 to support a corresponding number of tracks 210. For example, the right most bracket 230 in FIG. 6 could be formed having only two apertures 232. Varying track 210 numbers in this manner may not have been possible for a user installing a custom, multi-channel track 100.

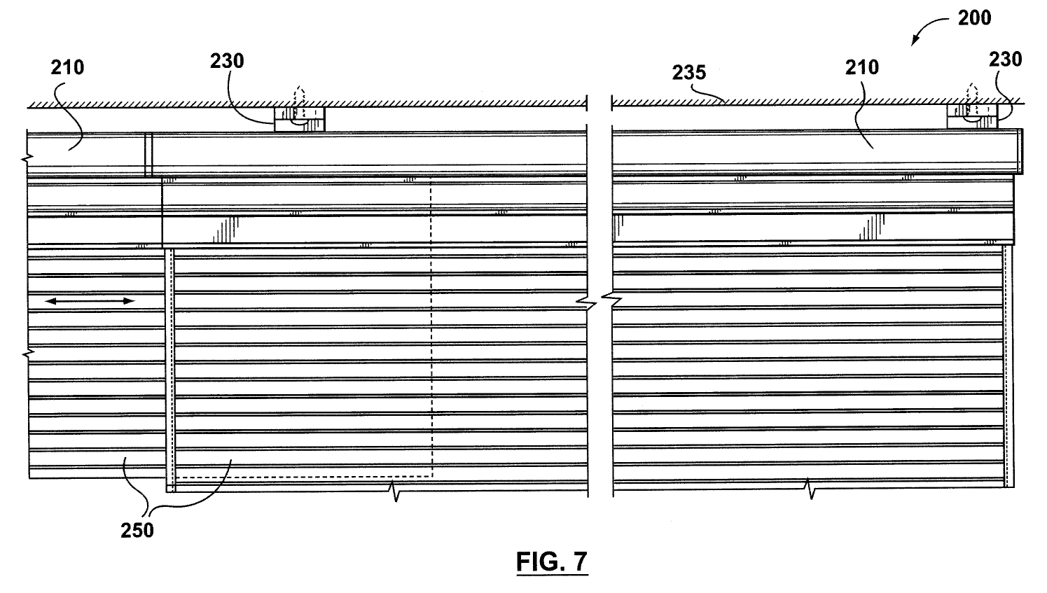

When assembled in the substantially parallel configuration shown in FIGS. 6 and 7, the sliders 220 in each track 210 can be moved so that the hanging panels 230 are separated from each other and so that the hanging panels 230 at least partially overlap each other, as indicated by the dotted lines in FIG. 7.

Each track 210 in the four-track window covering may support its own slider 220 and corresponding hanging panel 250 as described above. In one embodiment of a window covering constructed using the modular shade system 200, each slider 220 is free to move along the length of its respective track, independent of the other sliders 220 and hanging panels 250. In another embodiment of a window covering constructed using the modular shade system 200, at least a portion of the sliders 220 or hanging panels 250 are linked to each other so that the movement of any given slider 220 is translated to the associated, connected sliders 220. In this configuration, a user may move a plurality of connected sliders 220 from the open position to the closed position, or vice versa, simply by moving one of the sliders 220.

Each of the four tracks 210 in these configurations are supported by brackets 230 and may be attached using a nut 238 and bolt 237. The apertures 232 in the bracket 230 may be spaced apart from each other a distance that allows multiple tracks 210 to be installed without any track 210 or slider 220 interfering with operation of an adjacent track 210 or slider 220.

The outer surfaces of any track 210 may be treated to create an aesthetic effect desired by a user. For example, the outer surfaces of the track 210 may be polished metal or they may be painted or otherwise covered.

While the examples above described a window covering having i) a single track 210 and ii) four tracks 210, it is understood that a window covering constructed from the modular shade system 200 can comprise any number of tracks 210 desired by the user.

Also, while an exemplary embodiment of the track 210 has been described above, it is understood by those skilled in the art that the track 210 may be of any cross-sectional shape suitable for the uses described herein. For example, the track 210 cross-sections may be square, rectangular, hexagonal, triangular, and octagonal or any other suitable shape. It is also understood that an track 210 may not have a uniform cross-section over its entire length.

In addition, it is understood that while the track 210 is described as being extruded, it may also be formed by any other suitable process, including casting, forging, milling, machining and molding. Further, while the track 210 is described as being formed from aluminum, it is understood that the track 210 could be made from any other suitable material including, wood, steel, copper and plastic.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting, and it will be understood by persons skilled in the art that other variants and modifications may be made without departing from the scope of the invention as defined in the claims appended hereto.

1. A modular system for covering an object with a shade, the system comprising:
a plurality of substantially identical elongated track members, each track member defining a longitudinal channel therein;
at least one bracket adapted to secure a predetermined number of the plurality of track members in substantially parallel relation, wherein the predetermined number is selected based on a dimension of the object; and
a slider movably connected to each of the predetermined number of track members, the slider comprising a first end movably engaging the longitudinal channel of the track member and a second end adapted to be secured to an upper edge of the shade.

2. The system of claim 1, wherein the at least one bracket defines a plurality of apertures therein, wherein each aperture is adapted to secure one of the track members to the at least one bracket.

3. The system of claim 2, wherein the at least one bracket comprises a plurality of brackets, wherein each of a first portion of the plurality of brackets includes the predetermined number of apertures to secure the predetermined number of the plurality of track members to each of the first portion of the plurality of brackets, and each of a second portion of the plurality of brackets includes a number of apertures different from the predetermined number.

4. The system of claim 3, wherein at least a portion of the plurality of track members are cut from a single longer track member.

5. A method of providing a modular system for covering an object with a shade, the method comprising:
providing at least one elongated track member, the at least one track member defining a longitudinal channel therein;
cutting the at least one elongated track member into a predetermined number of sized track members, wherein the predetermined number of sized track members is based on a dimension of the object;
selecting a first group of brackets from a plurality of brackets, wherein the first group of brackets comprises at least one bracket having a number of apertures equal to the predetermined number; and
providing at least one slider to engage the longitudinal channel defined in each sized track member, each slider comprising a first end for movably engaging the longitudinal channel of the sized track member and a second end adapted to be secured to an upper edge of a shade.

6. The method of claim 5, further comprising the step of selecting a second group of brackets from the plurality of brackets for connecting a portion of the sized track members, wherein the second group of brackets comprises at least one bracket having a number of apertures that is different from the predetermined number.

7. The method of claim 6, further comprising the step of assembling the brackets and the sized track members, such that each sized track member is adjacent to at least one other sized track member.

8. The method of claim 7 further comprising securing the brackets to a surface proximate to the object.

9. The method of claim 7 further comprising the step of providing at least two sliders and linking the sliders so that the movement of any one slider results in the movement of at least one other slider.

10. The method of claim 7, wherein each of the predetermined number of the sized track members has substantially the same length.

11. The method of claim 7, wherein each of the predetermined number of the sized track members has a different length.

12. A modular system for covering an object with a shade, the object having a dimension, the system comprising:
a predetermined number of sized track members cut from at least one longer elongated track member, each sized track member defining a longitudinal channel therein; wherein the predetermined number is selected based on the dimension of the object;
a plurality of brackets for supporting the sized track members in a substantially parallel and adjacent relationship, the plurality of brackets comprising at least one first bracket, the at least one first bracket defining the predetermined number of apertures to secure the predetermined number of sized track members to the first bracket; and
a slider connected to each of the sized track members, the slider comprising a first end movably engaging the longitudinal channel of the sized track member, and a second end adapted to be secured to an upper edge of the shade.

13. The system of claim 12, wherein the plurality of brackets further comprise at least one second bracket defining a plurality of apertures, wherein the number of the apertures in the second bracket from the predetermined number of apertures defined in the first bracket.

14. The system of claim 13, wherein the sliders are connected such that movement of any one slider is translated into movement of at least one other slider.

15. The system of claim 13, wherein the sized track members are substantially the same length.

16. The system of claim 13, wherein at least a portion of the sized track members are different lengths.

17. A slider for supporting a hanging panel within a modular system for covering an object with a shade, the hanging panel having an attachment portion and a hanging portion, the slider comprising:
a track engaging section for movably engaging a supporting track member; and
a panel attachment section for supporting a corresponding attachment portion of the hanging panel,
wherein the panel attachment section comprises an elongated channel, the elongated channel having at least one open end and a gap defining a longitudinal opening along the elongated channel,
wherein the elongated channel is wider than the attachment portion of the hanging panel to slidingly receive the attachment portion via the at least one open end, and
wherein the gap is wider than the hanging portion of the hanging panel and narrower than the attachment portion of the hanging panel to slidingly receive the hanging portion of the hanging panel and contain the attachment portion of the hanging panel within the elongated channel.

18. The slider of claim 17, wherein the elongated channel has a generally circular cross-section.

19. The slider of claim 17, wherein the gap is substantially opposite the track engaging section.

20. The slider of claim 19, wherein the gap is between 1 mm and 10 mm in width.

21. The slider of claim 20, wherein the track engaging section comprises at least two rollers.
